(19) United States
(12) Patent Application Publication
(10) Pub. No.: US 2019/0281851 A1
(43) Pub. Date: Sep. 19, 2019

(54) Pure Collagen Milk Powder and Preparation Method Thereof

(71) Applicant: Hui NING, Dongguan (CN)

(72) Inventor: Hui NING, Dongguan (CN)

(21) Appl. No.: 16/336,430

(22) PCT Filed: Sep. 14, 2017
(86) PCT No.: PCT/CN2017/101743

§ 371 Date: Mar. 25, 2019

(30) Foreign Application Priority Data
Sep. 28, 2016 (CN) 201610856383.1

(51) Int. Cl. A23C 11/10; A23J 1/10; A23J 3/34; A23C 3/02

(52) U.S. Cl. CPC A23C 11/10; A23J 1/10; A23C 2210/05; A23C 3/02; A23J 3/342

(57) ABSTRACT

The invention relates to the technical field of collagen food. The pure collagen milk powder is prepared by concentrating and drying pure collagen milk, and the pure collagen milk is composed of the following raw materials in parts by weight: 10-80 parts of a pure collagen solution, 0.1-1 part of an emulsion stabilizer, 0.25-5 parts of white granulated sugar, 0.15-3 parts of salt, 0.01-0.5 part of a food flavor, and 20-90 parts of drinking water, wherein the pure collagen solution is a pure collagen solution containing small molecule short-chain peptides.

### TECHNICAL FIELD

The invention relates to the technical field of collagen food, in particular to a pure collagen milk powder and a preparation method thereof.

### DESCRIPTION OF RELATED ART

Health and longevity are the eternal pursuits of every member of human society, and they are also fatal injuries and pain points in human society.

Domestic and foreign medical experts believe that human physiological life can be up to 170 years old and human natural age can reach 120 years; however, the actual life expectancy is almost halved (currently China's average life expectancy is 76 years, one of the most important reasons is that the aging phenomenon comes down to the nutrition imbalance during the human life cycle, especially to the deficiency of the core nutrient-“collagen deficiency”!

Up to now, collagen, as the most core and important nutrient causing the most direct impact on the human life cycle health, longevity and evolution, is however, recognized at the latest and researched and utilized in a most fragmented way.

Collagen cannot be ingested in the human food chain, and it is difficult to transform and synthesize in human nutrition. When humans grow to 25 years old, collagen begins to lose. Nutritional imbalance and “collagen loss” lead to decreased function and immunity of various organs of the human body, decreased function of collagen synthesis in human fibroblasts, damage to various organs, connective tissues and bones and skin aging, and various diseases follow one after another, which seriously affects fertility, development and genetic inheritance. So far, humans have not found an effective method for nutritional balance. nutritionally, it is still believed that collagen is still of a zero bio-price, and is still in a stage of fuzzy awareness and fragmented research

Companies that produce collagen products at home and abroad purify collagen type I and then sell it as luxury health care products, beauty cosmetics, masks, and the like. These fragmented awareness and fragmented products cannot solve the fundamental problem.

Collagen is the most important gift from nature to human beings. Collagen types I-XXVII been found at present; as an important part of the organism composition, because of its great value to the organism, collagen has an important position and far-reaching influence in the field of human medicine and in terms of human health and longevity and human evolution.

At present, our good food structure is very unbalanced, and nature provides humans with two major types of renewable food: one is plants and the other is animals. Plants are collagen-free and therefore collagen can only be supplemented by collagen-rich animal skin, connective tissues, bones, cartilage, etc.

In animal skin, the content of proteins is 26.4%, 2.5 times more than that in pork, and more than 90% of the proteins are macromolecular collagen and elastin. The carbohydrate content is 4 times higher than that in pork, while the fat content is only ½ of that in pork.

Collagen, also known as collagen, is a biological polymer substance whose molecular structure is a spiral fibrous protein structure composed of three intertwined peptide chains and has a special GIY-Xaa-Yaa tripeptide unit. Collagen accounts for 25% to 30% of the total proteins in the human body and is the most abundant protein in the human body, equivalent to 6% of the body's weight. Collagen is distributed in various organs of human tissues. Each adult's body contains about 3,000 grams of collagen. Collagen is synthesized by fibroblasts and exists in connective tissues, bones, cartilages, ligaments, scleras, visceral intercellular substance, myocoel and skin. It plays the role of binding tissues in human cells and is called: “bone in the bone”, “skin in the skin”.

In addition to tryptophan and cysteine, collagen is rich in 18 amino acids, of which 7 are essential for maintaining human growth. In collagen, glycine accounts for 30% and proline and hydroxyproline account for about 25%, which is highest among all kinds of proteins. The content of alanine and glutamic acid is also high. Moreover, collagen also contains hydroxyproline and pyroglutamic acid which are rare in general proteins and hydroxyl lysine which is almost absent in other proteins. Therefore, the nutrition of collagen is very rich.

China is a big country for raising pigs. The amount of pigs is about 50% of the world, and 600 million pigs are slaughtered every year. At present, the number of live pigs in China is about 400-500 million, and the animal skin accounts for about 10% of each pig. There are 1.75 million tons of fresh animal skin by-products in a year, accounting for 14.58% of the animal skin of slaughtered pigs every year, with a utilization rate of less than 10%. According to the current population base in China, 13.5 kg of fresh animal skin are available for each person per year on average. According to the active ingredient, more than 10 g of small molecule short-chain peptide collagen can be enjoyed per person per day and can supplement the body's collagen loss.

The animal skin contains about 70%-75% water, 21%-23% protein, 1% fat, and 0.5% ash. The protein in the animal skin is mainly composed of collagen, with the content of 87.8%. Collagen has a unique three-strand supercoiled structure. The three chains are parallel to each other and are connected by hydrogen bonds between the chains. Therefore, collagen has very stable properties and is hardly decomposed at a general processing temperature or after being heated for a short time, so it is difficult to be absorbed by the body and is low in utilization rate if eaten directly. If collagen is hydrolyzed into a polypeptide, the digestion and absorption rate is almost 100%, and its nutritional and physiological functions are also significantly improved, such as: protecting the gastric mucosa and resisting ulcer, promoting skin collagen metabolism, inhibiting blood pressure rise, promoting calcium absorption and lowering the cholesterol level in serum, and having a good preventive and therapeutic effect on collagen diseases such as arthritis. In recent years, the development and utilization of collagen has attracted widespread attention. However, not all collagen peptides can be easily applied to different fields. The use of collagen peptides mainly depends on the molecular weight of collagen hydrolysates and the protection of heat-sensitive nutrient loss. In addition to providing human dietary nutrition balance, collagen peptides are used in medicine, food, cosmetics and fine chemical products. The molecular weight has become the standard for measuring product quality.

Collagen contains a variety of amino acids, of which 9 are essential for human life, such as glycine, alanine, glutamic acid, arginine, proline, hydroxyproline, aspartic acid, serine, and can be added to dairy products such as fruit milk, soy milk and milk. At present, collagen products available on the market at present are almost all purified type I and generally have the molecular weight of 1000-6000 Daltons, and the molecular weight of the collagen fully absorbed by the human body is generally less than 4000 Daltons. Therefore, a large part of collagen products on the market are generally difficult to be absorbed by the human body and have low nutrition level, which cause a lot of waste.

The Chinese invention patent No. 200510038809.4 discloses a collagen and a method for preparing collagen from poultry skin. Disclosed is a collagen prepared from poultry skin as a raw material, and the prepared poultry skin collagen is composed of chain a and chain b. A method for preparing the collagen from poultry skin comprises: soaking cleaned poultry skin with an alkali solution, and then washing the alkali-treated poultry skin with deionized water, soaking the treated poultry skin in an acidic buffer, filtering, centrifuging, collecting supernatant and dialyzing until the dialysate is neutral.

The Chinese invention patent No. 200810156070.0 discloses a method for preparing collagen, comprising the following steps: 1) pretreatment of raw material: removing fat and fascia from fresh burdock, and soaking with a 0.1±0.05% sodium carbonate solution for 4±2H, rinsing with distilled water several times and airing; 2) adding a proteolytic enzyme in the pretreated burdock, wherein the mass ratio of the proteolytic enzyme is 0.3±0.1 WT %; adding an acetic acid solution, slowly stirring at 1-12° C. for 3-5d; then centrifuging with a high-speed freezing centrifuge, collecting supernatant, and crudely extracting to obtain a collagen solution; and 3) purification of collagen: adding a H₂O₂ solution with a mass fraction of 1±0.5% to the crudely extracted collagen solution, mixing to be uniform and standing still for 4±2H; adjusting a pH value to 5±1 with a trisodium citrate solution, centrifuging, adding to the remaining solution a certain amount of sodium chloride for salting out, then placing precipitate in a dialysis bag and dialyzing with an acetic acid solution for 1±0.5d, and then dialyzing with distilled water for 3±1d, and changing dialysate 2-3 times a day, thus obtaining an aqueous solution of collagen.

The above two technical solutions will retain in the products a large amount of high-molecular collagen which is difficult to be absorbed by the human body, and also leave a large amount of collagen in the raw material which is not completely extracted, so the quality of the products are not high and serious waste is caused.

### BRIEF SUMMARY OF THE INVENTION

In order to overcome the shortcomings and deficiencies in the prior art, the object of the invention is to provide a pure collagen milk powder which has comprehensive nutrition and no odor and in which the content of small molecule short-chain peptides having a molecular weight of 1000-4000 Daltons is over 98%; and due to a small molecular weight, the pure collagen milk powder is easily absorbed by the human body, and has an absorption rate of 100%.

Another object of the invention is to provide a preparation method of a pure collagen milk powder, which can reduce the loss of heat-sensitive nutrients in pure collagen milk powder and can be put into large-scale industrial production due to the advantages of simple process, convenient operation control, stable quality, and high production efficiency.

The object of the invention is achieved by the following technical solution: a pure collagen milk powder prepared by concentrating and drying pure collagen milk, the pure collagen milk being composed of the following raw materials in parts by weight: 10-80 parts of a pure collagen solution, 0.1-1 part of an emulsion stabilizer, 0.25-5 parts of white granulated sugar, 0.15-3 parts of salt, 0.01-0.5 part of a food flavor, and 20-90 parts of drinking water, wherein the pure collagen solution is a pure collagen solution containing small molecule short-chain peptides.

The pure collagen milk powder of the invention has comprehensive nutrition and no odor, and the content of small molecule short-chain peptides having a molecular weight of 1000-4000 Daltons is over 98%; due to the small molecular weight, the pure collagen milk powder can be absorbed easily by the human body, with an absorption rate of 100%.

The pure collagen solution consists of the following raw materials in parts by weight:

Animal skin 40-60 parts;

Complex enzyme 0.1-1.2 parts; and

Drinking water 40-60 parts.

Preferably, the complex enzyme is a mixture consisting of collagenase, pepsin, trypsin and flavourzyme.

The pure collagen solution of the invention adopts collagenase for the first time, and the collagenase is a protein prepared by extracting from the histolytic Bacillus fusiformis and can specifically hydrolyze the three-dimensional helical structure of the natural collagen under physiological pH and temperature conditions, and can hydrolyze collagen components in connective tissues without damaging other proteins and tissues; pepsin is an acid protease that can decompose proteins in food into small peptide fragments; trypsin is an alkaline protease that can cleave the side carboxyl of lysine and arginine residues in a polypeptide chain; the flavourzyme is an alkaline protease that can cleave peptide bonds inside a polypeptide to form short-chain peptides. By complexing the collagenase, the pepsin, the trypsin and the flavourzyme, the complex enzyme of the invention can mimic the digestive environment in the human body, and can hydrolyze the collagen in the animal skin to obtain a pure collagen solution containing small molecule short-chain peptides.

More preferably, the complex enzyme is a mixture of collagenase, pepsin, trypsin and flavourzyme in a weight ratio of 0.5-1.5:1:0.8-1.2:1.5-2.5. By adjusting the weight ratio of the collagenase, the pepsin, the trypsin and the flavourzyme to 0.5-1.5:1:0.8-1.2:1.5-2.5, the four enzymes which are complexed have the best effect, improve the enzymatic efficiency and increase the yield and activity of collagen peptides.

The pure collagen solution of the invention has no odor, and the content of small molecule short-chain peptides having a molecular weight of 1000-4000 Daltons is over 98%; due to the small molecular weight, the pure collagen milk powder can be absorbed easily by the human body, with an absorption rate of 100%; the pure collagen solution of the invention is free of any chemicals except of enzymes, and thus is environmentally friendly.

Preferably, the preparation method of the pure collagen solution comprises the following steps:

a. pretreatment: washing 40-60 parts of animal skin, mechanically degreasing, cutting into strips, treating with alkali, rinsing for the first time, biologically degreasing and rinsing for the second time;

b. boiling: placing the animal skin, degreased and rinsed in the step a, in water, heating to 90-100° C., and boiling for 5-10 minutes;

c. mixing: heating 40-60 parts of drinking water to 40-55° C., adding 0.1-1.2 parts of a complex enzyme, and stirring to be uniform to obtain an enzyme solution; mincing the animal skin boiled in the step b, and placing into the enzyme solution, stirring to be uniform to obtain a mixture, wherein the complex enzyme is a mixture consisting of collagenase, pepsin, trypsin and flavourzyme;

d. grinding: grinding the mixture obtained in the step c to obtain an animal skin collagen slurry;

e. enzymatic hydrolysis: heating the animal skin collagen slurry obtained in the step d to 38-50° C., stirring and reacting for 3-5 hours to obtain an enzymatic hydrolyzate; and

f. enzyme deactivation: heating the enzymatic hydrolysate obtained in the step e to 85-95° C., and carrying out enzyme deactivation for 10-20 minutes to obtain a pure collagen solution containing small molecule short-chain peptides.

Preferably, the complex enzyme is a mixture consisting of collagenase, pepsin, trypsin and flavour protease in a weight ratio of 0.5-1.5:1:0.8-1.2:1.5-2.5. By adjusting the weight ratio of the collagenase, the pepsin, the trypsin and the flavourzyme to 0.5-1.5:1:0.8-1.2:1.5-2.5, the four enzymes which are complexed have the best effect, improve the enzymatic efficiency and increase the yield and activity of collagen peptides.

The animal skin used in the invention includes, but is not limited to, animal skins such as pigskin, cowhide, sheepskin, horseskin, donkey hide or fish skin, and other animal skins may be used in the invention. Any obvious substitutions, concluded without departing from the concept of the invention, fall within the scope of the invention.

The preparation method of the pure collagen solution of the invention can fully extract collagen in the animal skin to obtain a pure collagen solution containing small molecule short-chain peptides, can improve the yield and activity of the collagen peptide, and can be put into large-scale industrial production due to the advantages of simple process, convenient operation control, stable quality, and high production efficiency.

The preparation method of the pure collagen solution of the invention effectively improves the production efficiency by adopting a process where enzymatic hydrolysis and enzyme deactivation are respectively carried out once, as compared with the prior art where enzymatic hydrolysis and enzyme deactivation are respectively carried out twice; in addition, since enzymes used in the invention are selected scientifically in the invention, the yield of the collagen peptide is higher than that in the prior art.

The preparation method of the pure collagen solution of the invention adopts a complex enzyme to specifically hydrolyze and digest the three-dimensional helical structure of the natural collagen under physiological pH and temperature conditions, and hydrolyze and digest collagen components in connective tissues without damaging other proteins and tissues; when the enzymatic hydrolysis is complete, the animal skin becomes scattered, that is, the collagen is separated from other tissue components of the animal skin, and mutual enzymatic hydrolysis between different enzymes will not occur.

The preparation method of the pure collagen solution of the invention has the advantages that the production cycle is short, the cost is low, no toxic or harmful substances are generated, the pure collagen solution is safe and has no toxic or side effects, and environmental pollution caused by chemical means and damage to nutrients in the pure collagen solution can be effectively avoided.

Preferably, the step a specifically comprises the following steps:

a1. washing: putting 40-60 parts of fresh animal skin reaching the quarantine standard and having no drug residue into a stainless steel tank, unfreezing with drinking water, and washing;

a2. mechanical degreasing: depilating, by an animal skin depilator, the animal skin washed in the step a1, and then degreasing the depilated animal skin by a degreasing machine;

a3. cutting into strips: cutting the animal skin, degreased in the step a2, into animal skin strips having a width of 1-3 cm by using an animal skin cutting machine;

a4. alkali treatment: putting the animal skin, cut into strips in the step a3, into a double mixing mixer, adding sodium carbonate with a mass fraction of 0.3%-0.7% for alkali treatment, stirring and mixing for 3-7 minutes;

a5. primary rinsing: rinsing the animal skin, subjected to the alkali treatment in the step a4, with drinking water for 3-7 minutes, and then pouring the rinsing water out, and rinsing with drinking water again, and repeating the rinsing operation three times until the animal skin has no unpleasant odor or residual alkali odor;

a6. biological degreasing: degreasing the animal skin, rinsed in the step a5, in 38-50° C. hot water containing 0.1%-0.5% by weight of lipase; and

a7. secondary rinsing: rinsing the animal skin, subjected to the biological degreasing in step a6, with 38-55° C. hot water.

According to the preparation method of the pure collagen solution of the invention, the animal skin depilator is used for depilation treatment to remove residual pig hair on the animal skin; the mechanical degreasing by using the degreasing machine does not cause any pollution to the material, and does not change the original composition of the amino acids of the product; the animal skin is cut into strips by using the animal skin cutting machine, and the width of the animal skin strips is controlled to be 1-3 cm, which facilitates subsequent mincing and improves the mincing efficiency; and the original odor of the animal skin is completely removed by using alkali treatment, and only high-purity odorless edible collagen stock solution is left; by carrying out rinsing treatment for three times and controlling the rinsing time to 5-7 minutes, the unpleasant odor and residual alkali odor of the animal skin can be removed.

According to the invention, the rinsed animal skin is degreased in 38-50° C. hot water containing 0.1 wt %-0.5 wt % of lipase for 3-5 hours, and then rinsed with 38-55° C. hot water, so that all the fat remaining after mechanical degreasing by the degreasing machine is hydrolyzed and removed and only the high-purity odorless and fat-free edible collagen stock solution is left, which is more favorable for vacuum concentration and spray drying and especially important for preventing the pure collagen milk powder from fat oxidation during the shelf life to prolong the shelf period, improving the instant dissolution of the collagen milk powder and thus improving the quality of the pure collagen milk powder.

The step b specifically comprises: putting into a stainless steel hanging basket the animal skin degreased and rinsed in the step a, and using a rail crane to put the stainless steel hanging basket with the animal skin into a jacketed kettle containing drinking water, and heating to 90-100° C., boiling for 5-10 minutes until the animal skin is cooked medium well, wherein the stainless steel hanging basket is lifted twice during the boiling.

The medium well animal skin means that the animal skin can be plucked with chopsticks; lifting the stainless steel hanging basket twice in the middle can make the animal skin fully heated; the bottom of the stainless steel hanging basket is provided with an opening, which facilitates the discharge of the animal skin; the arrangement of the rail crane facilitates the processing or automatic operation of the animal skin. According to the preparation method of the pure collagen solution of the invention, by controlling the boiling temperature to 90-100° C. and controlling the boiling time to 5-10 minutes, the animal skin can be cooked medium well, and the three-dimensional helical structure of the collagen in the animal skin is opened, which facilitates the subsequent grinding and enzymatic hydrolysis and improves the efficiency of enzymatic hydrolysis. Preferably, in the step b, the water contained in the jacketed kettle is drinking water.

Preferably, the step c specifically comprises: heating the above-mentioned parts by weight of drinking water to 40-55° C., adding the above-mentioned parts by weight of the complex enzyme, putting into a barrel with a mixer and stirring to be uniform, thus obtaining an enzyme solution; lifting the stainless steel hanging basket with animal skin in the step b from the jacketed kettle, conveying to the top of a meat mincer by the rail crane, opening the bottom of the stainless steel hanging basket to charge the animal skin into a hopper of the meat mincer, and mincing the animal skin with a perforated plate with a diameter of 0.3-0.5 cm to obtain animal skin granules; and allowing the minced animal skin granules to directly drop into the barrel with a mixer, and stirring to be uniform to obtain a mixture.

According to the preparation method of the pure collagen solution of the invention, by controlling the temperature of the drinking water to 40-55° C., the complex enzyme has better activity. According to the preparation method of the invention, the efficiency of enzymatic hydrolysis can be improved by controlling the size of the minced animal skin granules to 0.3-0.5 cm.

The step d specifically comprises: putting the mixture obtained in the step c into a colloid mill with a fineness of 80 meshes for the first grinding, and then carrying out second grinding by using a colloid mill having a fineness of 200 meshes to obtain an animal skin collagen slurry under enzymatic hydrolysis.

According to the preparation method of the pure collagen solution of the invention, by carrying out grinding treatment twice, and controlling the finenesses of the two grindings to 80 meshes and 200 meshes respectively, the collagen is fully mechanically sheared and dispersed, which facilitates subsequent enzymatic hydrolysis and improves the efficiency of enzymatic hydrolysis.

Preferably, in the step e, the animal skin collagen slurry obtained in the step d is put into a reaction kettle, heated to 40-50° C., and then stirred for reaction for 4 hours to obtain an enzymatic hydrolyzate.

According to the preparation method of the pure collagen solution of the invention, by controlling the temperature of the enzymatic hydrolysis to 40-50° C. and controlling the time of enzymatic hydrolysis to 4 hours, the activity of the complex enzyme is optimized, the efficiency of enzymatic hydrolysis is improved, and the yield of the collagen peptide is increased.

Preferably, in the step f, the enzymatic hydrolysate obtained in the step e is heated to 85-95° C. for enzyme deactivation for 15 minutes, and the molecular weight of the small molecule short-chain peptides in the obtained pure collagen solution is 1000-4000 Daltons.

According to the preparation method of the pure collagen solution of the invention, by controlling the temperature of enzyme deactivation to 85-95° C. and controlling the time of enzyme deactivation to 15 minutes, the pure collagen solution having the small molecule short-chain peptides with a molecular weight of 1000-4000 Daltons is prevented from excessive enzymatic hydrolysis.

Preferably, each part of the emulsion stabilizer comprises the following raw materials in parts by weight: 2-5 parts of monoglyceride, 3-7 parts of sucrose ester, 3-5 parts of propylene glycol alginate, 2-7 parts of xanthan gum, 2-9 parts of guar gum, 0.5-0.8 part of d-isoascorbate, and 0.1-0.5 part of trisodium phosphate.

By using the above raw materials and strictly controlling the weight ratio of each raw material, the emulsion stabilizer of the invention can make the pure collagen milk more stable, does not have phase separation, does not aggregate, and has a long shelf life.

Preferably, the preparation method of a pure collagen milk comprises the following steps:

A. pretreatment of a pure collagen solution: carrying out testing, weighing, solution collection, degassing, filtering and cooling on the pure collagen solution;

B. sterilization of the pure collagen solution: pasteurizing and cooling the pretreated pure collagen solution;

C. material mixing for pure collagen milk: preheating the pasteurized and cooled pure collagen solution, adding remaining raw materials according to the weight ratio, and mixing; and

D. sterilization of the pure collagen milk: carrying out UHT sterilization on the mixed pure collagen milk and then cooling.

The preparation method of the pure collagen milk of the invention can improve the activity of the small molecule short-chain peptides in the pure collagen milk and can be put into large-scale industrial production due to the advantages of simple process, convenient operation control, stable quality, and high production efficiency.

Preferably, the step A specifically includes the following steps:

A1. detection: detecting and standardizing the drug residue, fat content, solid content, collagen content and collagen molecular weight of the pure collagen solution respectively;

A2. weighing: weighing the qualified pure collagen solution with a weighing scale

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 1-6° C.; and

A7. storage: temporarily storing the cooled pure collagen solution in a milk bin for less than 12 hours;

preferably, the pure collagen solution in the step A1 is the pure collagen solution prepared in the step f, and correspondingly, in the step A3, the temperature of the solution collection is 45-55° C.; the pure collagen solution in the step A1 may also be a commercially available pure collagen solution.

The preparation method of the pure collagen milk of the invention can ensure the quality of the obtained pure collagen milk by adopting the detecting step; by adopting the degassing step, part of gas in the pure collagen solution can be removed and the odor is removed; and by adopting the filtering step, large impurities in the pure collagen solution can be removed.

The step B specifically includes the following steps:

B1. preheating: preheating the pretreated pure collagen solution to 50-55° C.;

B2. cleaning: remove impurities from the preheated pure collagen solution;

B3. flashing: heating the cleaned pure collagen solution to 65-70° C. for flashing;

B4. pasteurization: holding the temperature of the flashed pure collagen solution at 80-90° C. for 10-20 seconds for pasteurization;

B5. cooling: cooling the pasteurized pure collagen solution to 6° C. or below; and

B6. storage: storing the cooled pure collagen solution at a temperature of 1-6° C.;

the preparation method of the pure collagen milk of the invention ensures the stable quality of the pure collagen milk by standardizing and sterilizing the pure collagen solution with a standardizing system through the steps of preheating, cleaning, flashing and pasteurization.

Preferably, the step C specifically includes the following steps:

C1. preheating: opening a pure collagen solution pipeline, and preheating a part of the above-mentioned parts by weight of the pure collagen solution to 55-60° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 10-20 minutes through a heat preservation tube.

C4. filtering: after heat preservation, filtering the mixture through a double filter;

C5. homogenizing: homogenizing the filtered mixture under a pressure of 170-190 bar;

C6. mixing: when the homogenized mixture passes through a four-way valve, starting a pure collagen solution blending line, mixing the mixture with another part of the pure collagen solution, and then entering a semi-finished product tank, and controlling the ratio of the mixture to the other part of the pure collagen solution to 1:4-6, stirring for 10-20 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

according to the preparation method of the pure collagen milk of the invention, the emulsion stabilizer, the white granulated sugar, the salt, the food flavor and the drinking water into a part of the pure collagen solution, and the obtained mixture is then mixed with another part of the pure collagen solution, thus obtaining a pure collagen milk with no phase separation, no aggregation and good stability. The storage time in the step C8 is less than 8 hours, which can ensure the continuous operation of the UHT sterilization.

The step D specifically includes the following steps:

D1. preheating: preheating the mixed pure collagen milk to 50-55° C.;

D2. degassing: degassing the preheated pure collagen milk;

D3. homogenizing: homogenizing the degassed pure collagen milk under a pressure of 190-210 bar at a temperature of 70-75° C.;

D4. UHT sterilization: holding the temperature of the homogenized pure collagen milk at 136-142° C. for 3-5 seconds for UHT sterilization; and

D5. storage: storing the sterilized pure collagen milk in a sterile tank for less than 48 hours at a temperature of less than 30° C.

The preparation method of the pure collagen milk of the invention can remove gas from the pure collagen milk by adopting the degassing step; the pure collagen milk can be made more uniform by using the homogenizing step; by adopting UHT sterilization, the sterilization time is short, and it has less effect on the nutrients in pure collagen milk; by using the sterile tank for storage, it can ensure the production time of a filling machine to be as long as possible.

Another object of the invention is achieved by the following technical solution: a preparation method of a pure collagen milk powder, comprising the following steps:

(1) vacuum concentration of pure collagen milk: concentrating pure collagen milk in vacuum, wherein the obtained pure collagen milk has a solid content of 48%-50%;

(2) first-stage drying of the pure collagen milk: spray-drying the pure collagen milk concentrated in vacuum, wherein the obtained pure collagen milk powder has a moisture of 7%-8%;

(3) second-stage drying of the pure collagen milk powder: fluidized bed drying and cooling the pure collagen milk powder subjected to the first-stage drying, wherein the obtained pure collagen milk powder has a moisture of 3%-5%;

(4) post-treatment: discharging, sieving and drying the pure collagen milk powder; and

(5) carrying out inspection and packaging.

The preparation method of a pure collagen milk powder can reduce the loss of heat-sensitive nutrients in the pure collagen milk powder and can be put into large-scale industrial production due to the advantages of simple process, convenient operation control, stable quality, and high production efficiency.

Preferably, the step (1) specifically includes the following steps:

(1.1) equipment preparation: during the operation of equipment, controlling the steam supply pressure to 1.0-1.2 MPa, and controlling the pressure of a hot-pressure pump to 0.4-0.6 MPa;

(1.2) production control: carrying out vacuum concentration by using a three-effect downstream falling film evaporator, wherein

first-effect vacuum concentration is carried under the following conditions: heating temperature of 70-83° C., separation chamber temperature of 63-75° C., heater vacuum degree of 0.035-0.050 MPa, and separation chamber vacuum degree of 0.045-0.068 MPa;

second-effect vacuum concentration is carried under the following conditions: heating temperature of 60-75° C., separation chamber temperature of 55-65° C., heater vacuum degree of 0.045-0.060 MPa, and separation chamber vacuum degree of 0.060-0.075 MPa;

second-effect vacuum concentration is carried under the following conditions: heating temperature of 55-68° C., separation chamber temperature of 45-55° C., heater vacuum degree of 0.055-0.070 MPa, separation chamber vacuum degree of 0.078-0.085 MPa, condenser vacuum degree of 0.078-0.085 MPa; and

(1.3) Detection: the pure collagen milk obtained after vacuum concentration has a milk solid content of 48%-50% and a milk concentration of 12-2513e.

The preparation method of the pure collagen milk powder of the invention is concentrated in vacuum by adopting the three-effect downstream falling film evaporator, and compared with the current mainstream double-effect rising film evaporator, the three-effect downstream falling film evaporator has the following outstanding advantages that: the yield per unit is increased, the energy consumption is reduced, and the cost is reduced; and since the evaporation temperature of the three-effect downstream falling film evaporator is low, the downstream falling film process reduces most of the heat-sensitive nutrient loss of the pure collagen milk, and the rich nutrition in the pure collagen milk is better protected.

Preferably, the step (2) specifically includes the following steps:

(2.1) disinfection of equipment: injecting hot water into the balancing tank before power-on, cleaning a high-pressure pump, a circulation pipeline and the balancing tank, holding the temperature of hot water at 90-100° C., and disinfecting for 10-20 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −60 Pa to 20 Pa, closing an air valve of the fluidized bed fan to the minimum state;

(2.3) spray drying: after the pure collagen milk concentrated in vacuum enters the balancing tank, when detecting that the concentration of concentrated milk is 12-25 Be and the temperature is 40-55° C., starting to feed materials, gradually increasing the pressure of the high-pressure pump and controlling the pressure of the high-pressure pump to 5-18 MPa, further controlling an inlet air temperature to 165-195° C., controlling an exhaust air temperature to 75-90° C., and controlling the pressure of the Roots blower to 0.01-0.02 MPa;

(2.4) detection: the pure collagen milk powder obtained after spray drying has a moisture of 7%-8%.

Preferably, the step (3) specifically includes the following steps:

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 60-70° C., 40-60° C., and ≤25° C., respectively; and

(3.3) detection: after drying and cooling by using the fluidized bed, the obtained pure collagen milk powder has a moisture of 3%-5%.

Spray drying mostly adopts one-stage drying by a spray drying tower at present, and the moisture of the powder discharged after the one-stage drying must reach about 3% at a time, so as to meet the requirements of the finished product. Since the one-stage drying is achieved only by increasing the temperature inside the tower, the nutrient loss is large for heat-sensitive pure collagen milk. The preparation method of the pure collagen milk powder of a invention adopts a two-stage drying method, the moisture of the pure collagen milk powder first reaches 7%-8% in the stage-I spray drying, and then the fluidized bed is used for secondary drying so that the moisture of the finished product reaches 3%-5%. Compared with the one-stage drying method, the two-stage drying method has great advantages: firstly, collagen milk powder can be dried at a lower temperature to reduce the loss of nutrients; secondly, two-stage drying can reduce energy consumption, and evaporation of 1 kg of water by two-stage drying only needs 4000 kJ of heat, however, it requires 5000 kJ of heat if using one-stage drying; thirdly, the two-stage drying can improve the particle size of collagen milk powder by spraying lecithin or by secondary agglomeration, thereby improving the instant solubility of the collagen milk powder; fourthly, the two-stage drying can achieve rapid cooling of the pure collagen milk powder and reduce the voidage of the milk powder, thus ensuring good quality of the milk powder.

The invention has the beneficial effects that the pure collagen milk powder of the invention has comprehensive nutrition and no odor, and the content of small molecule short-chain peptides having a molecular weight of 1000-4000 Daltons is over 98%; and due to the small molecular weight, the pure collagen milk powder can be absorbed easily by the human body, with an absorption rate of 100%.

According to the invention, collagen is innovatively processed into collagen milk directly and further processed into collagen milk powder. The production process of the collagen milk powder is an innovative process in the field; after entering the human body, the collagen can be synthesized or transformed into nutrients needed by the human body according to the physiological needs of the human body, so the nutritional value is high; in addition, the production cost is low and only 20-50% of the cost of the traditional dairy products; moreover, the content of active ingredients is much higher than that of the traditional dairy products, which is conducive to the realization of the national food supplement.

The preparation method of a pure collagen milk powder can reduce the loss of heat-sensitive nutrients in the pure collagen milk powder and can be put into large-scale industrial production due to the advantages of simple process, convenient operation control, stable quality, and high production efficiency.

### DETAILED DESCRIPTION OF THE INVENTION

For understanding of those skilled in the art, the invention will be further described in conjunction with embodiments, and the embodiments mentioned are not intended to limit the invention.

### Embodiment 1

A pure collagen milk powder prepared by concentrating and drying pure collagen milk, the pure collagen milk being composed of the following raw materials in parts by weight: 10 parts of a pure collagen solution, 0.1 part of an emulsion stabilizer, 0.25 parts of white granulated sugar, 0.15 parts of salt, 0.01 part of a food flavor, and 20 parts of drinking water, wherein the pure collagen solution is a pure collagen solution containing small molecule short-chain peptides.

The preparation method of a pure collagen solution comprises the following steps:

a. pretreatment: washing 40 parts of pigskin, mechanically degreasing, cutting into strips, treating with alkali, rinsing for the first time, biologically degreasing and rinsing for the second time;

a1. washing: putting 40 parts of fresh pigskin reaching the quarantine standard and having no drug residue into a stainless steel tank, unfreezing with drinking water, and washing;

a2. mechanical degreasing: depilating, by a pigskin depilator, the pigskin washed in the step a1, and then degreasing the depilated pigskin by a degreasing machine;

a3. cutting into strips: cutting the pigskin, degreased in the step a2, into pigskin strips having a width of 1 cm by using a pigskin cutting machine;

a4. alkali treatment: putting the pigskin, cut into strips in the step a3, into a double mixing mixer, adding sodium carbonate with a mass fraction of 0.3% for alkali treatment, stirring and mixing for 3 minutes;

a5. primary rinsing: rinsing the pigskin, subjected to the alkali treatment in the step a4, with drinking water for 3 minutes, and then pouring the rinsing water out, and rinsing with drinking water again, and repeating the rinsing operation three times until the pigskin has no unpleasant odor or residual alkali odor;

a6. biological degreasing: degreasing the pigskin, rinsed in the step a5, in 38° C. hot water containing 0.1% by weight of lipase for 3 hours; and

a7. secondary rinsing: rinsing the pigskin, subjected to the biological degreasing in step a6, with 38° C. hot water.

b. boiling: putting into a stainless steel hanging basket the pigskin degreased and rinsed in the step a, and using a rail crane to put the stainless steel hanging basket with the the pigskin into a jacketed kettle containing drinking water, and heating to 90° C., boiling for 10 minutes until the pigskin is cooked medium well, wherein the stainless steel hanging basket is lifted twice during the boiling;

c. mixing: heating 40 parts of drinking water to 40° C., adding 0.1 part of a complex enzyme, putting into a barrel with a mixer, stirring to be uniform, thus obtaining an enzyme solution; lifting the stainless steel hanging basket with the pigskin in the step b from the jacketed kettle, conveying to the top of a meat mincer by the rail crane, opening the bottom of the stainless steel hanging basket to charge the pigskin into a hopper of the meat mincer, and mincing the pigskin with a perforated plate with a diameter of 0.3 cm to obtain pigskin granules; and allowing the minced pigskin granules to directly drop into the barrel with a mixer, and stirring to be uniform to obtain a mixture, wherein the complex enzyme is a mixture consisting of collagenase, pepsin, trypsin and flavour protease in a weight ratio of 0.5:1:0.8:1.5;

d. putting the mixture obtained in the step c into a colloid mill with a fineness of 80 meshes for the first grinding, and then carrying out second grinding by using a colloid mill having a fineness of 200 meshes to obtain a pigskin collagen slurry under enzymatic hydrolysis;

e. enzymatic hydrolysis: heating the pigskin collagen slurry obtained in the step d to 40° C., stirring and reacting for 5 hours to obtain an enzymatic hydrolyzate; and

f. enzyme deactivation: heating the enzymatic hydrolysate obtained in the step e to 85° C., and carrying out enzyme deactivation for 20 minutes to obtain a pure collagen solution containing small molecule short-chain peptides having a molecular weight of 1000-4000 Daltons.

Each part of the emulsion stabilizer comprises the following raw materials in parts by weight: 2 parts of monoglyceride, 3 parts of sucrose ester, 3 parts of propylene glycol alginate, 2 parts of xanthan gum, 2 parts of guar gum, 0.5 part of d-isoascorbate, and 0.1 part of trisodium phosphate.

The preparation method of a pure collagen milk comprises the following steps:

A. pretreatment of a pure collagen solution: carrying out testing, weighing, solution collection, degassing, filtering and cooling on the pure collagen solution;

A1. detection: detecting and standardizing the drug residue, fat content, solid content, collagen content and collagen molecular weight of the pure collagen solution respectively;

A2. weighing: weighing the qualified pure collagen solution with a weighing scale;

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 1° C.; and

A7. storage: temporarily storing the cooled pure collagen solution in a milk bin for less than 12 hours;

B. sterilization of the pure collagen solution: pasteurizing and cooling the pretreated pure collagen solution;

B1. preheating: preheating the pretreated pure collagen solution to 50° C.;

B2. cleaning: remove impurities from the preheated pure collagen solution;

B3. flashing: heating the cleaned pure collagen solution to 65° C. for flashing;

B4. pasteurization: holding the temperature of the flashed pure collagen solution at 80° C. for 20 seconds for pasteurization;

B5. cooling: cooling the pasteurized pure collagen solution to 6° C. or below; and

B6. storage: storing the cooled pure collagen solution at a temperature of 1° C.;

C. material mixing for pure collagen milk: preheating the pasteurized and cooled pure collagen solution, adding remaining raw materials according to the weight ratio, and mixing; and

C1. preheating: opening a pure collagen solution pipeline, and preheating a part of the above-mentioned parts by weight of the pure collagen solution to 55° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 10 minutes through a heat preservation tube.

C4. filtering: after heat preservation, filtering the mixture through a double filter;

C5. homogenizing: homogenizing the filtered mixture under a pressure of 170 bar;

C6. mixing: when the homogenized mixture passes through a four-way valve, is starting a pure collagen solution blending line, mixing the mixture with another part of the pure collagen solution, and then entering a semi-finished product tank, and controlling the ratio of the mixture to the other part of the pure collagen solution to 1:4, stirring for 10 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

D. sterilization of the pure collagen milk: carrying out UHT sterilization on the mixed pure collagen milk and then cooling.

D1. preheating: preheating the mixed pure collagen milk to 50° C.;

D2. degassing: degassing the preheated pure collagen milk;

D3. homogenizing: homogenizing the degassed pure collagen milk under a pressure of 190 bar at a temperature of 70° C.;

D4. UHT sterilization: holding the temperature of the homogenized pure collagen milk at 136° C. for 5 seconds for UHT sterilization; and

D5. storage: storing the sterilized pure collagen milk in a sterile tank for less than 48 hours at a temperature of less than 30° C.

A preparation method of a pure collagen milk powder, comprising the following steps:

(1) vacuum concentration of pure collagen milk: concentrating pure collagen milk in vacuum, wherein the obtained pure collagen milk has a solid content of 48%;

(1.1) equipment preparation: during the operation of equipment, controlling the steam supply pressure to 1.0 MPa, and controlling the pressure of a hot-pressure pump to 0.4 MPa;

(1.2) production control: carrying out vacuum concentration by using a three-effect downstream falling film evaporator, wherein

first-effect vacuum concentration is carried under the following conditions: heating temperature of 70° C., separation chamber temperature of 63° C., heater vacuum degree of 0.035 MPa, and separation chamber vacuum degree of 0.045 MPa;

second-effect vacuum concentration is carried under the following conditions: heating temperature of 60° C., separation chamber temperature of 55° C., heater vacuum degree of 0.045 MPa, and separation chamber vacuum degree of 0.060 MPa;

third-effect vacuum concentration is carried under the following conditions: heating temperature of 55° C., separation chamber temperature of 45° C., heater vacuum degree of 0.055 MPa, separation chamber vacuum degree of 0.078 MPa, condenser vacuum degree of 0.078 MPa; and

(1.3) Detection: the pure collagen milk obtained after vacuum concentration has a milk solid content of 48% and a milk concentration of 1213e.

(2) first-stage drying of the pure collagen milk: spray-drying the pure collagen milk concentrated in vacuum, wherein the obtained pure collagen milk powder has a moisture of 7%;

(2.1) disinfection of equipment: injecting hot water into the balancing tank before power-on, cleaning a high-pressure pump, a circulation pipeline and the balancing tank, holding the temperature of hot water at 90° C., and disinfecting for 10 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −60 Pa, closing an air valve of the fluidized bed fan to the minimum state;

(2.3) spray drying: after the pure collagen milk concentrated in vacuum enters the balancing tank, when detecting that the concentration of concentrated milk is 12 Be and the temperature is 40° C., starting to feed materials, gradually increasing the pressure of the high-pressure pump and controlling the pressure of the high-pressure pump to 5 MPa, further controlling an inlet air temperature to 165° C., controlling an exhaust air temperature to 75° C., and controlling the pressure of the Roots blower to 0.01 MPa;

(2.4) detection: the pure collagen milk powder obtained after spray drying has a moisture of 7%.

(3) second-stage drying of the pure collagen milk powder: fluidized bed drying and cooling the pure collagen milk powder subjected to the first-stage drying, wherein the obtained pure collagen milk powder has a moisture of 3%;

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 60° C., 40° C., 20° C., respectively; and

(3.3) detection: after drying and cooling by using the fluidized bed, the obtained pure collagen milk powder has a moisture of 3%.

(4) post-treatment: discharging, sieving and drying the pure collagen milk powder; and

(5) carrying out inspection and packaging.

### Embodiment 2

A pure collagen milk powder prepared by concentrating and drying pure collagen milk, the pure collagen milk being composed of the following raw materials in parts by weight: 300 parts of a pure collagen solution, 0.3 part of an emulsion stabilizer, 2 parts of white granulated sugar, 1 parts of salt, 0.1 part of a food flavor, and 40 parts of drinking water, wherein the pure collagen solution is a pure collagen solution containing small molecule short-chain peptides.

The preparation method of a pure collagen solution comprises the following steps:

a. pretreatment: washing 45 parts of pigskin, mechanically degreasing, cutting into strips, treating with alkali, rinsing for the first time, biologically degreasing and rinsing for the second time;

a1. washing: putting 45 parts of fresh cowhide reaching the quarantine standard and having no drug residue into a stainless steel tank, unfreezing with drinking water, and washing;

a2. mechanical degreasing: depilating, by a cowhide depilator, the cowhide washed in the step a1, and then degreasing the depilated cowhide by a degreasing machine;

a3. cutting into strips: cutting the cowhide, degreased in the step a2, into cowhide strips having a width of 1.5 cm by using a cowhide cutting machine;

a4. alkali treatment: putting the cowhide, cut into strips in the step a3, into a double mixing mixer, adding sodium carbonate with a mass fraction of 0.4% for alkali treatment, stirring and mixing for 4 minutes;

a5. primary rinsing: rinsing the cowhide, subjected to the alkali treatment in the step a4, with drinking water for 4 minutes, and then pouring the rinsing water out, and rinsing with drinking water again, and repeating the rinsing operation three times until the cowhide has no unpleasant odor or residual alkali odor;

a6. biological degreasing: degreasing the cowhide, rinsed in the step a5, in 42° C. hot water containing 0.2% by weight of lipase for 3.5 hours; and

a7. secondary rinsing: rinsing the cowhide, subjected to the biological degreasing in step a6, with 42° C. hot water.

b. boiling: putting into a stainless steel hanging basket the pigskin degreased and rinsed in the step a, and using a rail crane to put the stainless steel hanging basket with the the pigskin into a jacketed kettle containing drinking water, and heating to 92° C., boiling for 8 minutes until the pigskin is cooked medium well, wherein the stainless steel hanging basket is lifted twice during the boiling;

c. mixing: heating 45 parts of drinking water to 45° C., adding 0.6 part of a complex enzyme, putting into a barrel with a mixer, stirring to be uniform, thus obtaining an enzyme solution; lifting the stainless steel hanging basket with the pigskin in the step b from the jacketed kettle, conveying to the top of a meat mincer by the rail crane, opening the bottom of the stainless steel hanging basket to charge the pigskin into a hopper of the meat mincer, and mincing the pigskin with a perforated plate with a diameter of 0.35 cm to obtain pigskin granules; and allowing the minced pigskin granules to directly drop into the barrel with a mixer, and stirring to be uniform to obtain a mixture, wherein the complex enzyme is a mixture consisting of collagenase, pepsin, trypsin and flavour protease in a weight ratio of 0.8:1:0.9:1.8;

d. putting the mixture obtained in the step c into a colloid mill with a fineness of 80 meshes for the first grinding, and then carrying out second grinding by using a colloid mill having a fineness of 200 meshes to obtain a pigskin collagen slurry under enzymatic hydrolysis;

e. enzymatic hydrolysis: heating the pigskin collagen slurry obtained in the step d to 42° C., stirring and reacting for 4.5 hours to obtain an enzymatic hydrolyzate; and

f. enzyme deactivation: heating the enzymatic hydrolysate obtained in the step e to 88° C., and carrying out enzyme deactivation for 18 minutes to obtain a pure collagen solution containing small molecule short-chain peptides having a molecular weight of 1000-4000 Daltons.

Each part of the emulsion stabilizer comprises the following raw materials in parts by weight: 6 parts of monoglyceride, 7 parts of sucrose ester, 3.5 parts of propylene glycol alginate, 3 parts of xanthan gum, 4 parts of guar gum, 0.6 part of d-isoascorbate, and 0.2 part of trisodium phosphate.

The preparation method of a pure collagen milk comprises the following steps:

A. pretreatment of a pure collagen solution: carrying out testing, weighing, solution collection, degassing, filtering and cooling on the pure collagen solution;

A1. detection: detecting and standardizing the drug residue, fat content, solid content, collagen content and collagen molecular weight of the pure collagen solution respectively;

A2. weighing: weighing the qualified pure collagen solution with a weighing scale

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 2° C.; and

A7. storage: temporarily storing the cooled pure collagen solution in a milk bin for less than 12 hours;

B. sterilization of the pure collagen solution: pasteurizing and cooling the pretreated pure collagen solution;

B1. preheating: preheating the pretreated pure collagen solution to 51° C.;

B2. cleaning: remove impurities from the preheated pure collagen solution;

B3. flashing: heating the cleaned pure collagen solution to 66° C. for flashing;

B4. pasteurization: holding the temperature of the flashed pure collagen solution at 82° C. for 18 seconds for pasteurization;

B5. cooling: cooling the pasteurized pure collagen solution to 6° C. or below; and

B6. storage: storing the cooled pure collagen solution at a temperature of 2° C.;

C. material mixing for pure collagen milk: preheating the pasteurized and cooled pure collagen solution, adding remaining raw materials according to the weight ratio, and mixing; and

C1. preheating: opening a pure collagen solution pipeline, and preheating a part of the above-mentioned parts by weight of the pure collagen solution to 56° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 12 minutes through a heat preservation tube.

C4. filtering: after heat preservation, filtering the mixture through a double filter;

C5. homogenizing: homogenizing the filtered mixture under a pressure of 175 bar;

C6. mixing: when the homogenized mixture passes through a four-way valve, starting a pure collagen solution blending line, mixing the mixture with another part of the pure collagen solution, and then entering a semi-finished product tank, and controlling the ratio of the mixture to the other part of the pure collagen solution to 1:4.5, stirring for 12 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

D. sterilization of the pure collagen milk: carrying out UHT sterilization on the mixed pure collagen milk and then cooling.

D1. preheating: preheating the mixed pure collagen milk to 51° C.;

D2. degassing: degassing the preheated pure collagen milk;

D3. homogenizing: homogenizing the degassed pure collagen milk under a pressure of 195 bar at a temperature of 71° C.;

D4. UHT sterilization: holding the temperature of the homogenized pure collagen milk at 138° C. for 4.5 seconds for UHT sterilization; and

D5. storage: storing the sterilized pure collagen milk in a sterile tank for less than 48 hours at a temperature of less than 30° C.

A preparation method of a pure collagen milk powder, comprising the following steps:

(1) vacuum concentration of pure collagen milk: concentrating pure collagen milk in vacuum, wherein the obtained pure collagen milk has a solid content of 48.5%;

(1.1) equipment preparation: during the operation of equipment, controlling the steam supply pressure to 1.1 MPa, and controlling the pressure of a hot-pressure pump to 0.5 MPa;

(1.2) production control: carrying out vacuum concentration by using a three-effect downstream falling film evaporator, wherein

first-effect vacuum concentration is carried under the following conditions: heating temperature of 74° C., separation chamber temperature of 66° C., heater vacuum degree of 0.038 MPa, and separation chamber vacuum degree of 0.050 MPa;

second-effect vacuum concentration is carried under the following conditions: heating temperature of 64° C., separation chamber temperature of 58° C., heater vacuum degree of 0.048 MPa, and separation chamber vacuum degree of 0.064 MPa;

third-effect vacuum concentration is carried under the following conditions: heating temperature of 58° C., separation chamber temperature of 48° C., heater vacuum degree of 0.080 MPa, separation chamber vacuum degree of 0.078-0.085 MPa, condenser vacuum degree of 0.080 MPa; and

(1.3) Detection: the pure collagen milk obtained after vacuum concentration has a milk solid content of 48.5% and a milk concentration of 15Bé.

(2) first-stage drying of the pure collagen milk: spray-drying the pure collagen milk concentrated in vacuum, wherein the obtained pure collagen milk powder has a moisture of 7.5%;

(2.1) disinfection of equipment: injecting hot water into the balancing tank before power-on, cleaning a high-pressure pump, a circulation pipeline and the balancing tank, holding the temperature of hot water at 92° C., and disinfecting for 12 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −50 Pa, closing an air valve of the fluidized bed fan to the minimum state;

(2.3) spray drying: after the pure collagen milk concentrated in vacuum enters the balancing tank, when detecting that the concentration of concentrated milk is 15 Be and the temperature is 44° C., starting to feed materials, gradually increasing the pressure of the high-pressure pump and controlling the pressure of the high-pressure pump to 8 MPa, further controlling an inlet air temperature to 175° C., controlling an exhaust air temperature to 78° C., and controlling the pressure of the Roots blower to 0.02 MPa;

(2.4) detection: the pure collagen milk powder obtained after spray drying has a moisture of 7.5%.

(3) second-stage drying of the pure collagen milk powder: fluidized bed drying and cooling the pure collagen milk powder subjected to the first-stage drying, wherein the obtained pure collagen milk powder has a moisture of 3.5%;

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 60° C., 42° C., 21° C., respectively; and

(3.3) detection: after drying and cooling by using the fluidized bed, the obtained pure collagen milk powder has a moisture of 3.5%.

(4) post-treatment: discharging, sieving and drying the pure collagen milk powder; and

(5) carrying out inspection and packaging.

### Embodiment 3

A pure collagen milk powder prepared by concentrating and drying pure collagen milk, the pure collagen milk being composed of the following raw materials in parts by weight: 45 parts of a pure collagen solution, 0.5 part of an emulsion stabilizer, 3 parts of white granulated sugar, 2 parts of salt, 0.2 part of a food flavor, and 55 parts of drinking water, wherein the pure collagen solution is a pure collagen solution containing small molecule short-chain peptides.

The preparation method of a pure collagen solution comprises the following steps:

a. pretreatment: washing 50 parts of sheepskin, mechanically degreasing, cutting into strips, treating with alkali, rinsing for the first time, biologically degreasing and rinsing for the second time;

a1. washing: putting 50 parts of fresh sheepskin reaching the quarantine standard and having no drug residue into a stainless steel tank, unfreezing with drinking water, and washing;

a2. mechanical degreasing: depilating, by a sheepskin depilator, the sheepskin washed in the step a1, and then degreasing the depilated sheepskin by a degreasing machine;

a3. cutting into strips: cutting the sheepskin, degreased in the step a2, into sheepskin strips having a width of 2 cm by using a sheepskin cutting machine;

a4. alkali treatment: putting the sheepskin, cut into strips in the step a3, into a double mixing mixer, adding sodium carbonate with a mass fraction of 0.5% for alkali treatment, stirring and mixing for 5 minutes;

a5. primary rinsing: rinsing the sheepskin, subjected to the alkali treatment in the step a4, with drinking water for 5 minutes, and then pouring the rinsing water out, and rinsing with drinking water again, and repeating the rinsing operation three times until the sheepskin has no unpleasant odor or residual alkali odor;

a6. biological degreasing: degreasing the sheepskin, rinsed in the step a5, in 45° C. hot water containing 0.3% by weight of lipase for 4 hours; and

a7. secondary rinsing: rinsing the sheepskin, subjected to the biological degreasing in step a6, with 48° C. hot water.

b. boiling: putting into a stainless steel hanging basket the pigskin degreased and rinsed in the step a, and using a rail crane to put the stainless steel hanging basket with the the pigskin into a jacketed kettle containing drinking water, and heating to 95° C., boiling for 7 minutes until the pigskin is cooked medium well, wherein the stainless steel hanging basket is lifted twice during the boiling;

c. mixing: heating 50 parts of drinking water to 48° C., adding 0.8 part of a complex enzyme, putting into a barrel with a mixer, stirring to be uniform, thus obtaining an enzyme solution; lifting the stainless steel hanging basket with the pigskin in the step b from the jacketed kettle, conveying to the top of a meat mincer by the rail crane, opening the bottom of the stainless steel hanging basket to charge the pigskin into a hopper of the meat mincer, and mincing the pigskin with a perforated plate with a diameter of 0.4 cm to obtain pigskin granules; and allowing the minced pigskin granules to directly drop into the barrel with a mixer, and stirring to be uniform to obtain a mixture, wherein the complex enzyme is a mixture consisting of collagenase, pepsin, trypsin and flavour protease in a weight ratio of 1:1:1:2;

d. putting the mixture obtained in the step c into a colloid mill with a fineness of 80 meshes for the first grinding, and then carrying out second grinding by using a colloid mill having a fineness of 200 meshes to obtain a pigskin collagen slurry under enzymatic hydrolysis;

e. enzymatic hydrolysis: heating the pigskin collagen slurry obtained in the step d to 45° C., stirring and reacting for 4 hours to obtain an enzymatic hydrolyzate; and

f. enzyme deactivation: heating the enzymatic hydrolysate obtained in the step e to 90° C., and carrying out enzyme deactivation for 15 minutes to obtain a pure collagen solution containing small molecule short-chain peptides having a molecular weight of 1000-4000 Daltons.

Each part of the emulsion stabilizer comprises the following raw materials in parts by weight: 3.5 parts of monoglyceride, 5 parts of sucrose ester, 4 parts of propylene glycol alginate, 4.5 parts of xanthan gum, 5.5 parts of guar gum, 0.65 part of d-isoascorbate, and 0.3 part of trisodium phosphate.

The preparation method of a pure collagen milk comprises the following steps:

A. pretreatment of a pure collagen solution: carrying out testing, weighing, solution collection, degassing, filtering and cooling on the pure collagen solution;

A1. detection: detecting and standardizing the drug residue, fat content, solid content, collagen content and collagen molecular weight of the pure collagen solution respectively;

A2. weighing: weighing the qualified pure collagen solution with a weighing scale

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 3° C.; and

A7. storage: temporarily storing the cooled pure collagen solution in a milk bin for less than 12 hours;

B. sterilization of the pure collagen solution: pasteurizing and cooling the pretreated pure collagen solution;

B1. preheating: preheating the pretreated pure collagen solution to 52° C.;

B2. cleaning: remove impurities from the preheated pure collagen solution;

B3. flashing: heating the cleaned pure collagen solution to 68° C. for flashing;

B4. pasteurization: holding the temperature of the flashed pure collagen solution at 85° C. for 15 seconds for pasteurization;

B5. cooling: cooling the pasteurized pure collagen solution to 6° C. or below; and

B6. storage: storing the cooled pure collagen solution at a temperature of 3° C.;

C. material mixing for pure collagen milk: preheating the pasteurized and cooled pure collagen solution, adding remaining raw materials according to the weight ratio, and mixing; and

C1. preheating: opening a pure collagen solution pipeline, and preheating a part of the above-mentioned parts by weight of the pure collagen solution to 57° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 15 minutes through a heat preservation tube.

C4. filtering: after heat preservation, filtering the mixture through a double filter;

C5. homogenizing: homogenizing the filtered mixture under a pressure of 180 bar;

C6. mixing: when the homogenized mixture passes through a four-way valve, starting a pure collagen solution blending line, mixing the mixture with another part of the pure collagen solution, and then entering a semi-finished product tank, and controlling the ratio of the mixture to the other part of the pure collagen solution to 1:5, stirring for 15 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

D. sterilization of the pure collagen milk: carrying out UHT sterilization on the mixed pure collagen milk and then cooling.

D1. preheating: preheating the mixed pure collagen milk to 52° C.;

D2. degassing: degassing the preheated pure collagen milk;

D3. homogenizing: homogenizing the degassed pure collagen milk under a pressure of 200 bar at a temperature of 72° C.;

D4. UHT sterilization: holding the temperature of the homogenized pure collagen milk at 139° C. for 4 seconds for UHT sterilization; and

D5. storage: storing the sterilized pure collagen milk in a sterile tank for less than 48 hours at a temperature of less than 30° C.

A preparation method of a pure collagen milk powder, comprising the following steps:

(1) vacuum concentration of pure collagen milk: concentrating pure collagen milk in vacuum, wherein the obtained pure collagen milk has a solid content of 49%;

(1.1) equipment preparation: during the operation of equipment, controlling the steam supply pressure to 1.1 MPa, and controlling the pressure of a hot-pressure pump to 0.5 MPa;

(1.2) production control: carrying out vacuum concentration by using a three-effect downstream falling film evaporator, wherein

first-effect vacuum concentration is carried under the following conditions: heating temperature of 78° C., separation chamber temperature of 68° C., heater vacuum degree of 0.042 MPa, and separation chamber vacuum degree of 0.052 MPa;

second-effect vacuum concentration is carried under the following conditions: heating temperature of 68° C., separation chamber temperature of 60° C., heater vacuum degree of 0.052 MPa, and separation chamber vacuum degree of 0.068 MPa;

third-effect vacuum concentration is carried under the following conditions: heating temperature of 62° C., separation chamber temperature of 50° C., heater vacuum degree of 0.062 MPa, separation chamber vacuum degree of 0.082 MPa, condenser vacuum degree of 0.082 MPa; and

(1.3) Detection: the pure collagen milk obtained after vacuum concentration has a milk solid content of 49% and a milk concentration of 18Bé.

(2.1) disinfection of equipment: injecting hot water into the balancing tank before power-on, cleaning a high-pressure pump, a circulation pipeline and the balancing tank, holding the temperature of hot water at 95° C., and disinfecting for 15 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −50 Pa, closing an air valve of the fluidized bed fan to the minimum state;

(2.3) spray drying: after the pure collagen milk concentrated in vacuum enters the balancing tank, when detecting that the concentration of concentrated milk is 18 Be and the temperature is 48° C., starting to feed materials, gradually increasing the pressure of the high-pressure pump and controlling the pressure of the high-pressure pump to 23 MPa, further controlling an inlet air temperature to 180° C., controlling an exhaust air temperature to 82° C., and controlling the pressure of the Roots blower to 0.01 MPa;

(2.4) detection: the pure collagen milk powder obtained after spray drying has a moisture of 7%.

(3) second-stage drying of the pure collagen milk powder: fluidized bed drying and cooling the pure collagen milk powder subjected to the first-stage drying, wherein the obtained pure collagen milk powder has a moisture of 4%;

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 65° C., 45° C., 22° C., respectively; and

(3.3) detection: after drying and cooling by using the fluidized bed, the obtained pure collagen milk powder has a moisture of 3%-5%.

(4) post-treatment: discharging, sieving and drying the pure collagen milk powder; and

(5) carrying out inspection and packaging.

### Embodiment 4

A pure collagen milk powder prepared by concentrating and drying pure collagen milk, the pure collagen milk being composed of the following raw materials in parts by weight: 60 parts of a pure collagen solution, 0.8 part of an emulsion stabilizer, 4 parts of white granulated sugar, 2.5 parts of salt, 0.4 part of a food flavor, and 70 parts of drinking water, wherein the pure collagen solution is a pure collagen solution containing small molecule short-chain peptides.

The preparation method of a pure collagen solution comprises the following steps:

a. pretreatment: washing 55 parts of horseskin, mechanically degreasing, cutting into strips, treating with alkali, rinsing for the first time, biologically degreasing and rinsing for the second time;

a1. washing: putting 55 parts of fresh horseskin reaching the quarantine standard and having no drug residue into a stainless steel tank, unfreezing with drinking water, and washing;

a2. mechanical degreasing: depilating, by a horseskin depilator, the horseskin washed in the step a1, and then degreasing the depilated horseskin by a degreasing machine;

a3. cutting into strips: cutting the horseskin, degreased in the step a2, into horseskin strips having a width of 2.5 cm by using a horseskin cutting machine;

a4. alkali treatment: putting the horseskin, cut into strips in the step a3, into a double mixing mixer, adding sodium carbonate with a mass fraction of 0.6% for alkali treatment, stirring and mixing for 6 minutes;

a5. primary rinsing: rinsing the horseskin, subjected to the alkali treatment in the step a4, with drinking water for 6 minutes, and then pouring the rinsing water out, and rinsing with drinking water again, and repeating the rinsing operation three times until the horseskin has no unpleasant odor or residual alkali odor;

a6. biological degreasing: degreasing the horseskin, rinsed in the step a5, in 48° C. hot water containing 0.4% by weight of lipase for 4.5 hours; and

a7. secondary rinsing: rinsing the horseskin, subjected to the biological degreasing in step a6, with 52° C. hot water.

b. boiling: putting into a stainless steel hanging basket the pigskin degreased and rinsed in the step a, and using a rail crane to put the stainless steel hanging basket with the the pigskin into a jacketed kettle containing drinking water, and heating to 98° C., boiling for 6 minutes until the pigskin is cooked medium well, wherein the stainless steel hanging basket is lifted twice during the boiling;

c. mixing: heating 55 parts of drinking water to 50° C., adding 1.0 part of a complex enzyme, putting into a barrel with a mixer, stirring to be uniform, thus obtaining an enzyme solution; lifting the stainless steel hanging basket with the pigskin in the step b from the jacketed kettle, conveying to the top of a meat mincer by the rail crane, opening the bottom of the stainless steel hanging basket to charge the pigskin into a hopper of the meat mincer, and mincing the pigskin with a perforated plate with a diameter of 0.45 cm to obtain pigskin granules; and allowing the minced pigskin granules to directly drop into the barrel with a mixer, and stirring to be uniform to obtain a mixture, wherein the complex enzyme is a mixture consisting of collagenase, pepsin, trypsin and flavour protease in a weight ratio of 1.2:1:1:2.2;

d. putting the mixture obtained in the step c into a colloid mill with a fineness of 80 meshes for the first grinding, and then carrying out second grinding by using a colloid mill having a fineness of 200 meshes to obtain a pigskin collagen slurry under enzymatic hydrolysis;

e. enzymatic hydrolysis: heating the pigskin collagen slurry obtained in the step d to 48° C., stirring and reacting for 3.5 hours to obtain an enzymatic hydrolyzate; and

f. enzyme deactivation: heating the enzymatic hydrolysate obtained in the step e to 92° C., and carrying out enzyme deactivation for 12 minutes to obtain a pure collagen solution containing small molecule short-chain peptides having a molecular weight of 1000-4000 Daltons.

Each part of the emulsion stabilizer comprises the following raw materials in parts by weight: 4 parts of monoglyceride, 6 parts of sucrose ester, 4.5 parts of propylene glycol alginate, 6 parts of xanthan gum, 7 parts of guar gum, 0.7 part of d-isoascorbate, and 0.4 part of trisodium phosphate.

The preparation method of a pure collagen milk comprises the following steps:

A. pretreatment of a pure collagen solution: carrying out testing, weighing, solution collection, degassing, filtering and cooling on the pure collagen solution;

A1. detection: detecting and standardizing the drug residue, fat content, solid content, collagen content and collagen molecular weight of the pure collagen solution respectively;

A2. weighing: weighing the qualified pure collagen solution with a weighing scale

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 5° C.; and

A7. storage: temporarily storing the cooled pure collagen solution in a milk bin for less than 12 hours;

B. sterilization of the pure collagen solution: pasteurizing and cooling the pretreated pure collagen solution;

B1. preheating: preheating the pretreated pure collagen solution to 54° C.;

B2. cleaning: remove impurities from the preheated pure collagen solution;

B3. flashing: heating the cleaned pure collagen solution to 69° C. for flashing;

B4. pasteurization: holding the temperature of the flashed pure collagen solution at 88° C. for 12 seconds for pasteurization;

B5. cooling: cooling the pasteurized pure collagen solution to 6° C. or below; and

B6. storage: storing the cooled pure collagen solution at a temperature of 5° C.;

C. material mixing for pure collagen milk: preheating the pasteurized and cooled pure collagen solution, adding remaining raw materials according to the weight ratio, and mixing; and

C1. preheating: opening a pure collagen solution pipeline, and preheating a part of the above-mentioned parts by weight of the pure collagen solution to 59° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 18 minutes through a heat preservation tube.

C4. filtering: after heat preservation, filtering the mixture through a double filter;

C5. homogenizing: homogenizing the filtered mixture under a pressure of 185 bar;

C6. mixing: when the homogenized mixture passes through a four-way valve, starting a pure collagen solution blending line, mixing the mixture with another part of the pure collagen solution, and then entering a semi-finished product tank, and controlling the ratio of the mixture to the other part of the pure collagen solution to 1:5.5, stirring for 18 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

D. sterilization of the pure collagen milk: carrying out UHT sterilization on the mixed pure collagen milk and then cooling.

D1. preheating: preheating the mixed pure collagen milk to 54° C.;

D2. degassing: degassing the preheated pure collagen milk;

D3. homogenizing: homogenizing the degassed pure collagen milk under a pressure of 205 bar at a temperature of 74° C.;

D4. UHT sterilization: holding the temperature of the homogenized pure collagen milk at 140° C. for 3.5 seconds for UHT sterilization; and

D5. storage: storing the sterilized pure collagen milk in a sterile tank for less than 48 hours at a temperature of less than 30° C.

A preparation method of a pure collagen milk powder, comprising the following steps:

(1) vacuum concentration of pure collagen milk: concentrating pure collagen milk in vacuum, wherein the obtained pure collagen milk has a solid content of 49.5%;

(1.1) equipment preparation: during the operation of equipment, controlling the steam supply pressure to 1.1 MPa, and controlling the pressure of a hot-pressure pump to 0.5 MPa;

(1.2) production control: carrying out vacuum concentration by using a three-effect downstream falling film evaporator, wherein

first-effect vacuum concentration is carried under the following conditions: heating temperature of 80° C., separation chamber temperature of 72° C., heater vacuum degree of 0.046 MPa, and separation chamber vacuum degree of 0.064 MPa;

second-effect vacuum concentration is carried under the following conditions: heating temperature of 72° C., separation chamber temperature of 62° C., heater vacuum degree of 0.056 MPa, and separation chamber vacuum degree of 0.072 MPa;

third-effect vacuum concentration is carried under the following conditions: heating temperature of 64° C., separation chamber temperature of 52° C., heater vacuum degree of 0.066 MPa, separation chamber vacuum degree of 0.084 MPa, condenser vacuum degree of 0.084 MPa; and

(1.3) Detection: the pure collagen milk obtained after vacuum concentration has a milk solid content of 49.5% and a milk concentration of 2213e.

(2) first-stage drying of the pure collagen milk: spray-drying the pure collagen milk concentrated in vacuum, wherein the obtained pure collagen milk powder has a moisture of 7.5%;

(2.1) disinfection of equipment: injecting hot water into the balancing tank before power-on, cleaning a high-pressure pump, a circulation pipeline and the balancing tank, holding the temperature of hot water at 98° C., and disinfecting for 18 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −, closing an air valve of the fluidized bed fan to the minimum state;

(2.3) spray drying: after the pure collagen milk concentrated in vacuum enters the balancing tank, when detecting that the concentration of concentrated milk is 18 Be and the temperature is 52° C., starting to feed materials, gradually increasing the pressure of the high-pressure pump and controlling the pressure of the high-pressure pump to 24 MPa, further controlling an inlet air temperature to 185° C., controlling an exhaust air temperature to 86° C., and controlling the pressure of the Roots blower to 0.02 MPa;

(2.4) detection: the pure collagen milk powder obtained after spray drying has a moisture of 7.5%.

(3) second-stage drying of the pure collagen milk powder: fluidized bed is drying and cooling the pure collagen milk powder subjected to the first-stage drying, wherein the obtained pure collagen milk powder has a moisture of 4.5%;

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 68° C., 55° C., 23° C., respectively; and

(3.3) detection: after drying and cooling by using the fluidized bed, the obtained pure collagen milk powder has a moisture of 4.5%.

(4) post-treatment: discharging, sieving and drying the pure collagen milk powder; and

(5) carrying out inspection and packaging.

### Embodiment 5

A pure collagen milk powder prepared by concentrating and drying pure collagen milk, the pure collagen milk being composed of the following raw materials in parts by weight: 80 parts of a pure collagen solution, 1 part of an emulsion stabilizer, 5 parts of white granulated sugar, 3 parts of salt, 0.5 part of a food flavor, and 90 parts of drinking water, wherein the pure collagen solution is a pure collagen solution containing small molecule short-chain peptides.

The preparation method of a pure collagen solution comprises the following steps:

a. pretreatment: washing 60 parts of donkey hide, mechanically degreasing, cutting into strips, treating with alkali, rinsing for the first time, biologically degreasing and rinsing for the second time;

a1. washing: putting 60 parts of fresh donkey hide reaching the quarantine standard and having no drug residue into a stainless steel tank, unfreezing with drinking water, and washing;

a2. mechanical degreasing: depilating, by a donkey hide depilator, the donkey hide washed in the step a1, and then degreasing the depilated donkey hide by a degreasing machine;

a3. cutting into strips: cutting the donkey hide, degreased in the step a2, into cowhide strips having a width of 3 cm by using a donkey hide cutting machine;

a4. alkali treatment: putting the donkey hide, cut into strips in the step a3, into a double mixing mixer, adding sodium carbonate with a mass fraction of 0.7% for alkali treatment, stirring and mixing for 7 minutes;

a5. primary rinsing: rinsing the donkey hide, subjected to the alkali treatment in the step a4, with drinking water for 7 minutes, and then pouring the rinsing water out, and rinsing with drinking water again, and repeating the rinsing operation three times until the donkey hide has no unpleasant odor or residual alkali odor;

a6. biological degreasing: degreasing the donkey hide, rinsed in the step a5, in 50° C. hot water containing 0.5% by weight of lipase for 5 hours;

a7. secondary rinsing: rinsing the donkey hide, subjected to the biological degreasing in step a6, with 55° C. hot water.

b. boiling: putting into a stainless steel hanging basket the pigskin degreased and rinsed in the step a, and using a rail crane to put the stainless steel hanging basket with the the pigskin into a jacketed kettle containing drinking water, and heating to 100° C., boiling for 5 minutes until the pigskin is cooked medium well, wherein the stainless steel hanging basket is lifted twice during the boiling;

c. mixing: heating 60 parts of drinking water to 55° C., adding 1.2 part of a complex enzyme, putting into a barrel with a mixer, stirring to be uniform, thus obtaining an enzyme solution; lifting the stainless steel hanging basket with the pigskin in the step b from the jacketed kettle, conveying to the top of a meat mincer by the rail crane, opening the bottom of the stainless steel hanging basket to charge the pigskin into a hopper of the meat mincer, and mincing the pigskin with a perforated plate with a diameter of 0.5 cm to obtain pigskin granules; and allowing the minced pigskin granules to directly drop into the barrel with a mixer, and stirring to be uniform to obtain a mixture, wherein the complex enzyme is a mixture consisting of collagenase, pepsin, trypsin and flavour protease in a weight ratio of 1.5:1:1.2:2.5;

d. putting the mixture obtained in the step c into a colloid mill with a fineness of 80 meshes for the first grinding, and then carrying out second grinding by using a colloid mill having a fineness of 200 meshes to obtain a pigskin collagen slurry under enzymatic hydrolysis;

e. enzymatic hydrolysis: heating the pigskin collagen slurry obtained in the step d to 50° C., stirring and reacting for 3 hours to obtain an enzymatic hydrolyzate; and

f. enzyme deactivation: heating the enzymatic hydrolysate obtained in the step e to 95° C., and carrying out enzyme deactivation for 10 minutes to obtain a pure collagen solution containing small molecule short-chain peptides having a molecular weight of 1000-4000 Daltons.

Each part of the emulsion stabilizer comprises the following raw materials in parts by weight: 5 parts of monoglyceride, 7 parts of sucrose ester, 5 parts of propylene glycol alginate, 7 parts of xanthan gum, 9 parts of guar gum, 0.8 part of d-isoascorbate, and 0.5 part of trisodium phosphate.

The preparation method of a pure collagen milk comprises the following steps:

A. pretreatment of a pure collagen solution: carrying out testing, weighing, solution collection, degassing, filtering and cooling on the pure collagen solution;

A1. detection: detecting and standardizing the drug residue, fat content, solid content, collagen content and collagen molecular weight of the pure collagen solution respectively;

A2. weighing: weighing the qualified pure collagen solution with a weighing scale

A3. solution collection: collecting the weighed pure collagen solution through a pipeline;

A4. degassing: degassing the pure collagen solution in the pipeline during the process of solution collection;

A5. filtering: filtering the pure collagen solution in the pipeline during the process of the solution collection;

A6. cooling: cooling the pure collagen solution after solution collection to 6° C.; and

A7. storage: temporarily storing the cooled pure collagen solution in a milk bin for less than 12 hours;

B. sterilization of the pure collagen solution: pasteurizing and cooling the pretreated pure collagen solution;

B1. preheating: preheating the pretreated pure collagen solution to 55° C.;

B2. cleaning: remove impurities from the preheated pure collagen solution;

B3. flashing: heating the cleaned pure collagen solution to 70° C. for flashing;

B4. pasteurization: holding the temperature of the flashed pure collagen solution at 90° C. for 10 seconds for pasteurization;

B5. cooling: cooling the pasteurized pure collagen solution to 6° C. or below; and

B6. storage: storing the cooled pure collagen solution at a temperature of 6° C.;

C. material mixing for pure collagen milk: preheating the pasteurized and cooled pure collagen solution, adding remaining raw materials according to the weight ratio, and mixing; and

C1. preheating: opening a pure collagen solution pipeline, and preheating a part of the above-mentioned parts by weight of the pure collagen solution to 60° C.;

C2. mixing: uniformly adding the above parts by weight of the emulsion stabilizer, the white granulated sugar, the salt, the food flavor and the drinking water to the preheated pure collagen solution through a feeder to obtain a mixture;

C3. heat preservation: carrying out heat preservation on the mixture for 20 minutes through a heat preservation tube.

C4. filtering: after heat preservation, filtering the mixture through a double filter;

C5. homogenizing: homogenizing the filtered mixture under a pressure of 190 bar;

C6. mixing: when the homogenized mixture passes through a four-way valve, starting a pure collagen solution blending line, mixing the mixture with another part of the pure collagen solution, and then entering a semi-finished product tank, and controlling the is ratio of the mixture to the other part of the pure collagen solution to 1:6, stirring for 20 minutes, sampling and detecting to obtain pure collagen milk;

C7. cooling: cooling the mixed pure collagen milk to 6° C. or below; and

C8. storage: storing the cooled pure collagen milk for less than 8 hours at a temperature of less than 10° C.;

D. sterilization of the pure collagen milk: carrying out UHT sterilization on the mixed pure collagen milk and then cooling.

D1. preheating: preheating the mixed pure collagen milk to 55° C.;

D2. degassing: degassing the preheated pure collagen milk;

D3. homogenizing: homogenizing the degassed pure collagen milk under a pressure of 210 bar at a temperature of 75° C.;

D4. UHT sterilization: holding the temperature of the homogenized pure collagen milk at 142° C. for 3 seconds for UHT sterilization; and

D5. storage: storing the sterilized pure collagen milk in a sterile tank for less than 48 hours at a temperature of less than 30° C.

A preparation method of a pure collagen milk powder, comprising the following steps:

(1) vacuum concentration of pure collagen milk: concentrating pure collagen milk in vacuum, wherein the obtained pure collagen milk has a solid content of 50%;

(1.1) equipment preparation: during the operation of equipment, controlling the steam supply pressure to 1.2 MPa, and controlling the pressure of a hot-pressure pump to 0.6 MPa;

(1.2) production control: carrying out vacuum concentration by using a three-effect downstream falling film evaporator, wherein

first-effect vacuum concentration is carried under the following conditions: heating temperature of 83° C., separation chamber temperature of 75° C., heater vacuum degree of 0.050 MPa, and separation chamber vacuum degree of 0.068 MPa;

second-effect vacuum concentration is carried under the following conditions: heating temperature of 75° C., separation chamber temperature of 65° C., heater vacuum degree of 0.060 MPa, and separation chamber vacuum degree of 0.075 MPa;

third-effect vacuum concentration is carried under the following conditions: heating temperature of 68° C., separation chamber temperature of 55° C., heater vacuum degree of 0.070 MPa, separation chamber vacuum degree of 0.078-0.085 MPa, condenser vacuum degree of 0.085 MPa; and

(1.3) Detection: the pure collagen milk obtained after vacuum concentration has a milk solid content of 48%-50% and a milk concentration of 12-2513e.

(2) first-stage drying of the pure collagen milk: spray-drying the pure collagen milk concentrated in vacuum, wherein the obtained pure collagen milk powder has a moisture of 8%;

(2.1) disinfection of equipment: injecting hot water into the balancing tank before power-on, cleaning a high-pressure pump, a circulation pipeline and the balancing tank, holding the temperature of hot water at 100° C., and disinfecting for 20 minutes;

(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −20 Pa, closing an air valve of the fluidized bed fan to the minimum state;

(2.3) spray drying: after the pure collagen milk concentrated in vacuum enters the balancing tank, when detecting that the concentration of concentrated milk is 25 Be and the temperature is 55° C., starting to feed materials, gradually increasing the pressure of the high-pressure pump and controlling the pressure of the high-pressure pump to 18 MPa, further controlling an inlet air temperature to 195° C., controlling an exhaust air temperature to 90° C., and controlling the pressure of the Roots blower to 0.01 MPa;

(2.4) detection: the pure collagen milk powder obtained after spray drying has a moisture of 8%.

(3) second-stage drying of the pure collagen milk powder: fluidized bed drying and cooling the pure collagen milk powder subjected to the first-stage drying, wherein the obtained pure collagen milk powder has a moisture of 5%;

(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;

(3.2) hot air drying: adjusting the inlet air temperatures of stages I, II and III of the fluidized bed to 70° C., 60° C., 24° C., respectively; and

(3.3) detection: after drying and cooling by using the fluidized bed, the obtained pure collagen milk powder has a moisture of 5%.

(4) post-treatment: discharging, sieving and drying the pure collagen milk powder; and

(5) carrying out inspection and packaging.

The test report of the pure collagen milk powder prepared in Embodiments 1-5 is shown in Table 1:

TABLE 1

| | National | | | | | |
|---|---|---|---|---|---|---|
| Test item | standard | Embodiment 1 | Embodiment 2 | Embodiment 3 | Embodiment 4 | Embodiment 5 |
| Odor | Minor | No | No | No | No | No |
| The content of peptides | ≥75% | 98.5% | 98.8% | 99.2% | 99.1% | 98.7% |
| (having a molecular weight | | | | | | |
| of 1000-4000 Daltons) in | | | | | | |
| total proteins | | | | | | |
| Absorption rate of the | ≥85% | 100% | 100% | 100% | 100% | 100% |
| human body | | | | | | |
| pH | 7.0-8.0 | 7.4 | 7.5 | 7.5 | 7.5 | 7.4 |
| Total number of bacteria | ≤30000 | 1200 | 1100 | 1000 | 1050 | 1150 |
| (cfu/g) | | | | | | |
| Number of coliform | ≤30 | 8 | 10 | 12 | 11 | 9 |
| bacteria (MPN/100 g) | | | | | | |
| Number of molds and | ≤50 | 5 | 7 | 8 | 6 | 4 |
| yeasts | | | | | | |
| Pathogenic bacteria | Not | Negative | Negative | Negative | Negative | Negative |
| | detectable | | | | | |

It can be seen from the above table that the pure collagen milk powder of the invention has comprehensive nutrition and no odor, and the content of small molecule short-chain peptides having a molecular weight of 1000-4000 Daltons is over 98%; due to the small molecular weight, the pure collagen milk powder can be absorbed easily by the human body, with an absorption rate of 100%; moreover, bacteria, fungi and pathogenic bacteria are extremely low in content and the pure collagen milk powder is environmentally friendly and can be used to supplement and balance the loss of collagen in the human body.

The above-described embodiments are preferred embodiments of the invention, and the invention may also be implemented in other ways, and any obvious alternatives, made without departing from the concept of the invention, fall within the scope of the invention.

1. A pure collagen milk powder, prepared by concentrating and drying pure collagen milk, wherein the pure collagen milk is composed of the following raw materials in parts by weight:

| | | |
|---|---|---|
| pure collagen milk solution | 10-80 | parts |
| emulsion stabilizer | 0.1-1 | part |
| white granulated sugar | 0.25-5 | parts |
| salt | 0.15-3 | parts |
| food flavor | 0.01-0.5 | part |
| drinking water | 20-90 | parts |

the pure collagen solution is a pure collagen solution containing small molecule short-chain peptides.

2. The pure collagen milk powder according to claim 1, wherein a preparation method of the pure collagen solution comprises the following steps:
a. pretreatment: washing 40-60 parts of animal skin, mechanically degreasing, cutting into strips, treating with alkali, rinsing for the first time, biologically degreasing and rinsing for the second time;
b. boiling: placing the animal skin, degreased and rinsed in the step a, in water, heating to 90-100° C., and boiling for 5-10 minutes;
c. mixing: heating 40-60 parts of drinking water to 40-55° C., adding 0.1-1.2 parts of a complex enzyme, and stirring to be uniform to obtain an enzyme solution; mincing the animal skin boiled in the step b, and placing into the enzyme solution, stirring to be uniform to obtain a mixture, wherein the complex enzyme is a mixture consisting of collagenase, pepsin, trypsin and flavourzyme;
d. grinding: grinding the mixture obtained in the step c to obtain an animal skin collagen slurry;
e. enzymatic hydrolysis: heating the animal skin collagen slurry obtained in the step d to 38-50° C., stirring and reacting for 3-5 hours to obtain an enzymatic hydrolyzate; and
f. enzyme deactivation: heating the enzymatic hydrolysate obtained in the step e to 85-95° C., and carrying out enzyme deactivation for 10-20 minutes to obtain a pure collagen solution containing small molecule short-chain peptides.

3. The pure collagen milk powder according to claim 2, wherein the step a specifically comprises the following steps:
a1. washing: putting 40-60 parts of fresh animal skin reaching the quarantine standard and having no drug residue into a stainless steel tank, unfreezing with drinking water, and washing;
a2. mechanical degreasing: depilating, by an animal skin depilator, the animal skin washed in the step a1, and then degreasing the depilated animal skin by a degreasing machine;
a3. cutting into strips: cutting the animal skin, degreased in the step a2, into animal skin strips having a width of 1-3 cm by using an animal skin cutting machine;
a4. alkali treatment: putting the animal skin, cut into strips in the step a3, into a double mixing mixer, adding sodium carbonate with a mass fraction of 0.3%-0.7% for alkali treatment, stirring and mixing for 3-7 minutes;
a5. primary rinsing: rinsing the animal skin, subjected to the alkali treatment in the step a4, with drinking water for 3-7 minutes, and then pouring the rinsing water out, and rinsing with drinking water again, and repeating the rinsing operation three times until the animal skin has no unpleasant odor or residual alkali odor;
a7. secondary rinsing: rinsing the animal skin, subjected to the biological degreasing in step a6, with 38-55° C. hot water.
the step b specifically comprises: putting into a stainless steel hanging basket the animal skin degreased and rinsed in the step a, and using a rail crane to put the stainless steel hanging basket with the animal skin into a jacketed kettle containing drinking water, and heating to 90-100° C., boiling for 5-10 minutes until the animal skin is cooked medium well, wherein the stainless steel hanging basket is lifted twice during the boiling;
the step c specifically comprises: heating the above-mentioned parts by weight of drinking water to 40-55° C., adding the above-mentioned parts by weight of the complex enzyme, putting into a barrel with a mixer and stirring to be uniform, thus obtaining an enzyme solution; lifting the stainless steel hanging basket with animal skin in the step b from the jacketed kettle, conveying to the top of a meat mincer by the rail crane, opening the bottom of the stainless steel hanging basket to charge the animal skin into a hopper of the meat mincer, and mincing the animal skin with a perforated plate with a diameter of 0.3-0.5 cm to obtain animal skin granules; and allowing the minced animal skin granules to directly drop into the barrel with a mixer, and stirring to be uniform to obtain a mixture;
the step d specifically comprises: putting the mixture obtained in the step c into a colloid mill with a fineness of 80 meshes for the first grinding, and then carrying out second grinding by using a colloid mill having a fineness of 200 meshes to obtain an animal skin collagen slurry under enzymatic hydrolysis.

4. The pure collagen milk powder according to claim 1, wherein each part of the emulsion stabilizer comprises the following raw materials in parts by weight:

| | | |
|---|---|---|
| monoglyceride | 2-5 | parts |
| sucrose ester | 3-7 | parts |
| propylene glycol alginate | 3-5 | parts |
| xanthan gum | 2-7 | parts |
| guar gum | 2-9 | parts |
| d-isoascorbate | 0.5-0.8 | parts |
| trisodium phosphate | 0.1-0.5 | part |

5. The pure collagen milk powder according to claim 1, wherein a preparation method of the pure collagen solution comprises the following steps:
A. pretreatment of a pure collagen solution: carrying out testing, weighing, solution collection, degassing, filtering and cooling on the pure collagen solution;
B. sterilization of the pure collagen solution: pasteurizing and cooling the pretreated pure collagen solution;
C. material mixing for pure collagen milk: preheating the pasteurized and cooled pure collagen solution, adding remaining raw materials according to the weight ratio, and mixing; and
D. sterilization of the pure collagen milk: carrying out UHT sterilization on the mixed pure collagen milk and then cooling.

6. The pure collagen milk powder according to claim 5, wherein the step A specifically comprises the following steps:
A1. detection: detecting and standardizing the drug residue, fat content, solid content, collagen content and collagen molecular weight of the pure collagen solution respectively;
A2. weighing: weighing the qualified pure collagen solution with a weighing scale
A3. solution collection: collecting the weighed pure collagen solution through a pipeline;
A4. degassing: degassing the pure collagen solution in the pipeline during the process of solution collection;
A5. filtering: filtering the pure collagen solution in the pipeline during the process of the solution collection;
A6. cooling: cooling the pure collagen solution after solution collection to 1-6° C.; and
A7. storage: temporarily storing the cooled pure collagen solution in a milk bin for less than 12 hours;
the step B specifically comprises the following steps:
B1. preheating: preheating the pretreated pure collagen solution to 50-55° C.;
B2. cleaning: remove impurities from the preheated pure collagen solution;
B3. flashing: heating the cleaned pure collagen solution to 65-70° C. for flashing;
B4. pasteurization: holding the temperature of the flashed pure collagen solution at 80-90° C. for 10-20 seconds for pasteurization;
B5. cooling: cooling the pasteurized pure collagen solution to 6° C. or below; and
B6. storage: storing the cooled pure collagen solution at a temperature of 1-6° C.;
the step C specifically comprises the following steps:
C1. preheating: opening a pure collagen solution pipeline, and preheating a part of the above-mentioned parts by weight of the pure collagen solution to 55-60° C.;
C2. mixing: uniformly adding the above parts by weight of the emulsion stabilizer, the white granulated sugar, the salt, the food flavor and the drinking water to the preheated pure collagen solution through a feeder to obtain a mixture;
C3. heat preservation: carrying out heat preservation on the mixture for 10-20 minutes through a heat preservation tube.
C4. filtering: after heat preservation, filtering the mixture through a double filter;
C5. homogenizing: homogenizing the filtered mixture under a pressure of 170-190 bar;
C6. mixing: when the homogenized mixture passes through a four-way valve, starting a pure collagen solution blending line, mixing the mixture with another part of the pure collagen solution, and then entering a semi-finished product tank, and controlling the ratio of the mixture to the other part of the pure collagen solution to 1:4-6, stirring for 10-20 minutes, sampling and detecting to obtain pure collagen milk;
C7. cooling: cooling the mixed pure collagen milk to 6° C. or below; and
C8. storage: storing the cooled pure collagen milk for less than 8 hours at a temperature of less than 10° C.;
the step D specifically comprises the following steps:
D1. preheating: preheating the mixed pure collagen milk to 50-55° C.;
D2. degassing: degassing the preheated pure collagen milk;
D3. homogenizing: homogenizing the degassed pure collagen milk under a pressure of 190-210 bar at a temperature of 70-75° C.;
D4. UHT sterilization: holding the temperature of the homogenized pure collagen milk at 136-142° C. for 3-5 seconds for UHT sterilization; and
D5. storage: storing the sterilized pure collagen milk in a sterile tank for less than 48 hours at a temperature of less than 30° C.

7. The preparation method of a pure collagen milk powder according to claim 1, comprising the following steps:
(1) vacuum concentration of pure collagen milk: concentrating pure collagen milk in vacuum, wherein the obtained pure collagen milk has a solid content of 48%-50%;
(2) first-stage drying of the pure collagen milk: spray-drying the pure collagen milk concentrated in vacuum, wherein the obtained pure collagen milk powder has a moisture of 7%-8%;
(3) second-stage drying of the pure collagen milk powder: fluidized bed drying and cooling the pure collagen milk powder subjected to the first-stage drying, wherein the obtained pure collagen milk powder has a moisture of 3%-5%;
(4) post-treatment: discharging, sieving and drying the pure collagen milk powder; and
(5) carrying out inspection and packaging.

8. The preparation method of a pure collagen milk powder according to claim 7, wherein the step (1) specifically comprises the following steps:
(1.1) equipment preparation: during the operation of equipment, controlling the steam supply pressure to 1.0-1.2 MPa, and controlling the pressure of a hot-pressure pump to 0.4-0.6 MPa;
(1.2) production control: carrying out vacuum concentration by using a three-effect downstream falling film evaporator, wherein
first-effect vacuum concentration is carried under the following conditions: heating temperature of 70-83° C., separation chamber temperature of 63-75° C., heater vacuum degree of 0.035-0.050 MPa, and separation chamber vacuum degree of 0.045-0.068 MPa;
second-effect vacuum concentration is carried under the following conditions: heating temperature of 60-75° C., separation chamber temperature of 55-65° C., heater vacuum degree of 0.045-0.060 MPa, and separation chamber vacuum degree of 0.060-0.075 MPa;
second-effect vacuum concentration is carried under the following conditions: heating temperature of 55-68° C., separation chamber temperature of 45-55° C., heater vacuum degree of 0.055-0.070 MPa, separation chamber vacuum degree of 0.078-0.085 MPa, condenser vacuum degree of 0.078-0.085 MPa;
(1.3) Detection: the pure collagen milk obtained after vacuum concentration has a milk solid content of 48%-50% and a milk concentration of 12-25Bé.

9. The preparation method of a pure collagen milk powder according to claim 7, wherein the step (2) specifically comprises the following steps:
(2.1) disinfection of equipment: injecting hot water into the balancing tank before power-on, cleaning a high-pressure pump, a circulation pipeline and the balancing tank, holding the temperature of hot water at 90-100° C., and disinfecting for 10-20 minutes;
(2.2) equipment preparation: When a spray drying tower is powered on, powering on an induced draft fan, an air blower, a fluidized bed fan, a Roots blower, a powder conveyor, and a powder blowing valve sequentially, and then adjusting an air valve of the induced draft fan to form a negative pressure state in the drying tower, and when the negative pressure is −60 Pa to 20 Pa, closing an air valve of the fluidized bed fan to the minimum state;
(2.3) spray drying: after the pure collagen milk concentrated in vacuum enters the balancing tank, when detecting that the concentration of concentrated milk is 12-25 Bé and the temperature is 40-55° C., starting to feed materials, gradually increasing the pressure of the high-pressure pump and controlling the pressure of the high-pressure pump to 5-18 MPa, further controlling an inlet air temperature to 165-195° C., controlling an exhaust air temperature to 75-90° C., and controlling the pressure of the Roots blower to 0.01-0.02 MPa;
(2.4) detection: the pure collagen milk powder obtained after spray drying has a moisture of 7%-8%.

10. The preparation method of a pure collagen milk powder according to claim 7, wherein The step D specifically includes the following steps:
(3.1) pressure balance: when the pure collagen milk powder falls into the fluidized bed, adjusting the pressure in the fluidized bed by adjusting an air inlet volume and an exhaust air volume of the fluidized bed, so that the pressure in the fluidized bed keeps balance with the pressure in the drying tower;
(3.2) hot air drying: adjusting the inlet air temperatures of stages I, II and III of the fluidized bed to 60-70° C., 40-60° C., and ≤25° C., respectively; and
(3.3) detection: after drying and cooling by using the fluidized bed, the obtained pure collagen milk powder has a moisture of 3%-5%.
